(19) United States
(12) Patent Application Publication
(10) Pub. No.: US 2023/0357670 A1
(43) Pub. Date: Nov. 9, 2023

(54) POLYSACCHARIDE COMPOSITION AND METHOD FOR REDUCING PROTEIN ADSORPTION

(71) Applicant: National Taipei University of Technology, Taipei (TW)

(72) Inventors: Hsu-Wei Fang, Taipei City (TW); Chen-Ying Su, Taipei City (TW); You-Cheng Chang, Taipei City (TW); Pin-Hsuan Huang, Taipei City (TW); Ling-Hsiang Hsu, Taipei City (TW)

(73) Assignee: National Taipei University of Technology, Taipei (TW)

(21) Appl. No.: 17/883,129

(22) Filed: Aug. 8, 2022

(30) Foreign Application Priority Data
May 9, 2022 (TW) 111117385

(51) Int. Cl. A61K 31/734; A61K 31/737; A61K 31/785

(52) U.S. Cl. CPC A61K 31/734; A61K 31/737; A61K 31/785

(57) ABSTRACT

Provided are a polysaccharide composition and method capable of reducing, whether during pre-wear immersion or during post-wear cleaning, the amount of protein adsorbed on hard contact lenses and orthokeratology lenses. The polysaccharide composition and method reduce the amount of protein adsorbed on hard contact lenses and thereby prevent corneal abrasions and inflammations of the conjunctiva and cornea.

### BACKGROUND OF THE INVENTION

### Field of the Invention

The present disclosure relates to a polysaccharide composition and method for reducing protein adsorption and, more particularly, to a hard contact lens cleaning solution or multipurpose solution capable of reducing protein adsorption.

### Description of the Prior Art

Contact lens multipurpose solutions are intended to achieve functions, such as cleaning, disinfecting, and storing a contact lens. Some are even manufactured with the expectation to provide lubrication and thereby mitigate wearer discomfort. The cleaning function involves removing dirt and impurity particles from the surface of a contact lens and clearing the contact lens of eye discharge (which contains protein and the like) otherwise adsorbed on the eyeball. The disinfection function is conducive to reduction of microorganisms on the eyeball surface and prevent corneal infections. The storage function achieves preservation by soaking the contact lens for the sake of sterilization, using some preservatives. The lubrication function involves forming a moisturizing layer on the contact lens to moisturize the contact lenes and reduce wear-induced eye dryness.

A study shows that, during the step of immersing contact lenses in multipurpose solutions and the subsequent cleaning and rubbing step, dirt, proteins and lipids adsorbed on the contact lenses become detached but not completely removed. As a result, an increasingly large amount of dirt, proteins and lipids are adsorbed on the contact lenses in regular use, contributing to bacterial colonies formed on the contact lenses to the detriment of eye health. Another study shows that the risk of bacterial infection will increase if the cleaning and rubbing step is omitted from a hard contact lens cleaning process [1]. Regarding multipurpose solutions for use with hard contact lenses or orthokeratology lenses, although hydrogen peroxide and a neutralizing tablet can remove proteins and lipids adsorbed on the contact lenses, both the hydrogen peroxide and the neutralizing tablet render the surfaces of orthokeratology lenses hydrophobic and thus cause discomfort to wearers [2].

Among their functions, contact lens multipurpose solutions have their role focused on removing proteins from contact lenses, for example, using enzymes to reduce the amount of proteins adsorbed on the contact lenses [3]. Hydranate (a chelating agent) inhibits formation of ionic bonds and thereby prevents protein adsorption on the surfaces of contact lenses [4]. Furthermore, negative ion molecules of sodium citrate bind to positive ion molecules of proteins to remove the proteins from the contact lenses [4]. However, the multipurpose solutions' focusing on removing proteins from contact lenses has a drawback: some tear film proteins can maintain their bactericidal function only when having activity; thus, the multipurpose solutions have to remove denatured proteins from the contact lenses in order to prevent wearer discomfort and inflammations. Barniak and others compared five different contact lens multipurpose solutions and came up with findings as follows: the multipurpose solutions vary in efficacy of lysozyme activity, from 4.0% to 90.1%; if the multipurpose solutions contain hydranate and sulfobetaine, the multipurpose solutions can prevent lysozyme and lactoferrin from denaturing [5].

As soon as a contact lens is placed on the human cornea, the contact lens comes into contact with proteins, with the proteins being mostly adsorbed on the contact lens firmly. A cleaning solution can effectively remove less than 50% the proteins from the contact lens [6]. Proteins are an important ingredient of human tear film and play important roles in, for example, protecting the surface of the eyeball against microorganism infections, controlling delivery and metabolism of cell membrane-related substances, and regulating immune responses and antioxidant activity [7]. Once adsorbed on contact lenses, proteins may be affected by lens materials, protein concentration, protein structure and charged states in tears. Lysozyme, lactoferrin and albumin are the most-studied proteins adsorbed on contact lenses [8]. Tear film has pH of about 7.4; thus, lysozyme (pH 11.4) and lactoferrin (pH 8.7) in tear film carry positive charges, whereas albumin (pH 5.2) carries negative charges [9]. Proteins can be adsorbed on any surfaces; hydrophobic amino acids are well protected inside protein molecules, whereas hydrophilic amino acids (charged or not charged) are located outside to interact with the other molecules in the surroundings. When the charged ones come into contact with the other ones carrying opposite charges, adsorption is augmented; meanwhile, the protein structure is reconstructed in order to ensure energy reduction. However, when the protein structure is damaged because of the reconstruction, the proteins deposit or trigger immune responses. On the whole, proteins can be readily adsorbed on hydrogel soft contact lenses at the rate of about 100 μg per lens, but the total protein adsorption level of high-water-content (greater than 50%), ionic hydrogel is 400˜2000 μg per lens. In an attempt to address hydrophobicity issues, silicon hydrogel soft contact lenses have to undergo special surface treatment to the disadvantage of protein adsorption. On average, the total protein adsorption level of silicon hydrogel is less than 30 μg per lens, much less than any type of hydrogel lenses [6].

Although overnight wear orthokeratology lenses are enclosed in tear film proteins, the orthokeratology lenses are different from diurnal soft contact lenses mainly in that the orthokeratology lenses are in an eye closure state which is airtight and has little air exchange. Therefore, a study suggests a considerable increase in secretory immunoglobulin A and albumin content in tear film protein secreted overnight. Conversely, the study shows that the amount of lactoferrin, apolipoprotein and lysozyme secreted nocturnally is the same as that secreted diurnally [10]. The study also shows that the amount of secretory immunoglobulin A is 0.04 mg/ml diurnally but increases to 0.2 mg/ml at sleep and increases to 0.5 mg/ml in the case of wearing orthokeratology lenses [11]. Yet another study shows that siloxane may be introduced into a hard contact lens to increase oxygen transmission rate but render it hydrophobic, causing lipid hydrophobic ends in the tears to be adsorbed on the contact lens, causing the hydrophilic ends of the contact lens material to be expelled and exposed in the tears, reducing the hydrophobicity of the contact lens material, thereby allowing the hydrophilic ends of proteins to be adsorbed on the contact lens [12]. Therefore, the equilibrium of molecules on the surface of the eyeball alters as soon as a contact lens, whether soft contact lens or orthokeratology lens, is worn thereon, and thus the protein adsorption and a series of biological effects arising therefrom are always issues of concern.

Nonetheless, existing technologies mostly use surfactants and proteolytic enzymes (proteases) to break down and remove proteins adsorbed on contact lenses, albeit inefficiently or irritatingly. Therefore, the aforesaid issues need a novel cleaning solution.

### SUMMARY OF THE INVENTION

In view of the aforesaid drawbacks of the prior art, it is an objective of the present disclosure to provide a polysaccharide composition for reducing protein adsorption, essentially comprising alginic acid, carrageenan and buffer solution.

In an embodiment, the composition essentially comprises γ-polyglutamic acid (γ-PGA).

In an embodiment, the ratio of the alginic acid to the carrageenan is 1:1.

In an embodiment, both the alginic acid and the carrageenan have a concentration of 1˜10 mg/ml.

In an embodiment, both the alginic acid and the carrageenan have a concentration of 2.25˜9 mg/ml.

In a preferred embodiment, the buffer solution has a pH of 6.5˜7.5.

In an embodiment, the composition of the present disclosure is a hard contact lens cleaning solution or multipurpose solution.

The present disclosure further provides a method of using the composition of the present disclosure to manufacture a reagent for reducing protein adsorption.

In an embodiment, the reagent is a hard contact lens cleaning solution or multipurpose solution.

### BRIEF DESCRIPTION OF THE DRAWINGS

The above description and the description below can be better understood by referring to the accompanying drawings. For the sake of illustration, the accompanying drawings depict the preferred, specific embodiments of the present disclosure.

The Accompanying Drawings

FIG. 1 is a bar chart of the amount of protein adsorbed on contact lenses when alginic acid and carrageenan multipurpose solutions of different concentrations and commercially-available multipurpose solutions are in use. They are compared with 2.25 mg/ml of alginic acid and carrageenan multipurpose solutions, using t-test, *P<0.05 or ***P<0.001.

FIG. 2 is a bar chart of the amount of protein adsorbed on contact lenses when polysaccharide multipurpose solution which contains γ-polyglutamic acid (γ-PGA), alginic acid and carrageenan multipurpose solution which does not contain γ-PGA, and commercially-available multipurpose solutions are in use. They are compared with polysaccharide multipurpose solution which contains γ-PGA, using t-test and *P<0.05.

### DETAILED DESCRIPTION OF THE EMBODIMENTS

Technical features, including specific features, are disclosed in the appended claims. The technical features of the present disclosure are illustrated by embodiments, depicted by accompanying drawings, and described below.

Unless otherwise defined, all technical and scientific terms used herein and in the appended claims are comprehensible to persons skilled in the art. Unless otherwise specified, expressions descriptive of an odd number, such as “a,” “one” and “the,” and the like, may indicate one or more objects. Unless otherwise specified, the conjunctions “and” and “or” may also mean “and/or.” Furthermore, the terms “comprise” and “include” are open-ended and do not indicate limitation. The aforesaid definitions refer to term definition and shall not be interpreted as restrictive of the scope of the present invention.

The term “hard contact lens” used herein means a hard contact lens or an orthokeratology lens.

The present disclosure provides a polysaccharide composition for reducing protein adsorption, essentially comprising alginic acid, carrageenan and buffer solution.

In an embodiment, the alginic acid has a molecular weight of about 120,000˜190,000 g/mol, and the carrageenan has a molecular weight of about 560.5˜580.5 g/mol.

In an embodiment, the composition further comprises γ-polyglutamic acid (γ-PGA).

In an embodiment, the γ-PGA has a molecular weight of about 1,024, 000 g/mol.

In another embodiment, the composition further comprises: an antiseptic, for example, polyhexamethylene biguanide hydrochloride (PHMB); and a non-ionic surfactant, for example, Poloxamer-407.

In a preferred embodiment, the concentration of γ-PGA is 1.5% (v/v).

In an embodiment, a ratio of the alginic acid to the carrageenan is 1:1.

In an embodiment, both the alginic acid and the carrageenan have a concentration of 1˜10 mg/ml.

In a preferred embodiment, both the alginic acid and the carrageenan have a concentration of 2.25˜9 mg/ml.

In a preferred embodiment, the buffer solution has a pH of 6.5˜7.5.

In a preferred embodiment, the buffer solution comprises ethylenediaminetetraacetic acid disodium (EDTA·2Na), calcium chloride (CaCl₂), potassium chloride (KCl), sodium chloride (NaCl), and sodium hydrogen phosphate (Na₂HPO₄).

In an embodiment, the composition of the present disclosure is a hard contact lens cleaning solution or multipurpose solution.

The present disclosure further provides a method of using the composition of the present disclosure to manufacture a reagent for reducing protein adsorption.

In an embodiment, the reagent is a hard contact lens cleaning solution or multipurpose solution.

In some embodiments, the solution provided by the present disclosure and intended to handle hard contact lenses is a solution for preserving hard contact lenses (i.e., contact lens preserving solution) or a solution for cleaning hard contact lenses (i.e., contact lens cleaning solution). In some embodiments, the solution provided by the present disclosure and intended to handle hard contact lenses selectively comprises a surfactant and/or a moisturizer.

### Embodiment 1

Method of Preparing Multipurpose Solution

The preparation of 100 ml of multipurpose solution involves adding 0.2 g of EDTA·2Na, 0.015 g of CaCl₂, 0.15 g of KCl, 0.45 g of NaCl and 1.8 g of Na₂HPO₄ to 100 ml of secondary water to form a buffer solution, adding 1.5 g of γ-PGA and 0.75 g of Poloxamer-407 to the buffer solution, and filtering the resultant buffer solution with a filtering membrane with pores of a diameter of 0.22 μm before its preservation begins. Then, the preparation process requires adding alginic acid (0.225˜0.9 g), carrageenan (0.225˜0.9 g) and 0.5 μl antiseptic (polyhexamethylene biguanide hydrochloride, PHMB) to the buffer solution. The multipurpose solution is measured with a pH meter to ensure that the pH of the buffer solution falls within the range of 6.5˜7.5.

Ongoing Adsorption of Protein and Cholesterol on Contact Lens and Cleaning Step

A contact lens is immersed in bionic tears at 37° C. for 8 hours before being taken out and moved to the multipurpose solution of the present disclosure or a commercially-available multipurpose solution and then immersed therein at 37° C. for 16 hours before being taken out and rubbed. The rubbing step entails placing the contact lens at the center of the palm, washing the contact lens from the center and outward, and then rubbing the concave surface of the lens (from the center and outward) for 20 seconds, placing the contact lens in new bionic tears, and repeating the immersion and rubbing steps three times. Three contact lenses (N=3) are used in each experiment.

The bionic tears (Table 1) [13] prepared to include the same ingredients as the human tears comprise salts, lipids, and proteins (albumin 0.2 mg/mL and lysozyme 2 mg/mL).

TABLE 1
Ingredients of artificial tears

| | concentration |
|---|---|
| ingredient | (mg/ml) |
| NaCl | 5.26 |
| KCl | 1.19 |
| Na₂CO₃ | 1.27 |
| KHCO₃ | 0.30 |
| CaCl₂ | 0.07 |
| HCl | 0.94 |
| Na₂HPO₄ | 3.41 |
| ProClin 300 | 200 μl/L |
| Na₃C₆H₅O₇ | 0.44 |
| Urea | 0.072 |
| Glucose | 0.036 |
| Oleic acid | 0.0018 |
| Oleic acid | 0.012 |
| methyl ester | |
| Phosphatidylcholine | 0.0005 |
| Triolein | 0.016 |
| Cholesterol | 0.0018 |
| Cholesteryl oleate | 0.024 |
| Lysozyme | 2 |
| Albumin | 0.2 |

Protein Measurement Procedure

Plotting Standard Curve

Protein Reagent A and Protein Reagent S are mixed at a proportion of 50:1 to form Protein Reagent A′, using Bio-Rad DC protein quantitative analysis reagent. With solvents comprising different single protein artificial tears, 100 μl of standard protein solution is consecutively transferred from eight standard protein solutions of concentrations of 0, 0.05, 0.1, 0.2, 0.4, 0.8, 1.6, 3.2 mg/ml to 15 ml centrifuge tubes, respectively. Then, 500 μl of Protein Reagent A′ is added to the 15 ml centrifuge tubes, and the mixtures therein undergo vortex mixing for 10 seconds. After that, 4000 μl of Protein Reagent B is added to the 15 ml centrifuge tubes, and the mixtures therein undergo vortex mixing for 10 seconds. Next, the 15 ml centrifuge tubes stand still for 15 minutes. Finally, absorbance (with wavelength being set to 750 nm and the test being finished in 1 hour) of the mixtures in the 15 ml centrifuge tubes is measured with an ELISA (enzyme-linked immunosorbent assay) reader.

Protein Orthokeratology Lens Test Procedure

Initial protein solution concentration is tested. The orthokeratology lenses are immersed in a lens residual protein solution, multipurpose solution post-rinsing solution, and multipurpose solution post-immersion solution→concentration of the proteins adsorbed on the orthokeratology lenses is calculated. Protein Reagent A and Protein Reagent S are mixed at a proportion of 50:1 to form Protein Reagent A′. 100 μl of a sample is transferred to a 15 ml centrifuge tube. Then, 500 μl of Protein Reagent A′ is added to the 15 ml centrifuge tube, and the mixture therein undergoes vortex mixing for 10 seconds. After that, 4000 μl of Protein Reagent B is added to the 15 ml centrifuge tube, and the mixture therein undergoes vortex mixing for 10 seconds. Next, the 15 ml centrifuge tube stands still for 15 minutes. Finally, absorbance (with wavelength being set to 750 nm and the test being finished in 1 hour) of the mixture in the 15 ml centrifuge tube is measured with an ELISA (enzyme-linked immunosorbent assay) reader.

Experimental Results

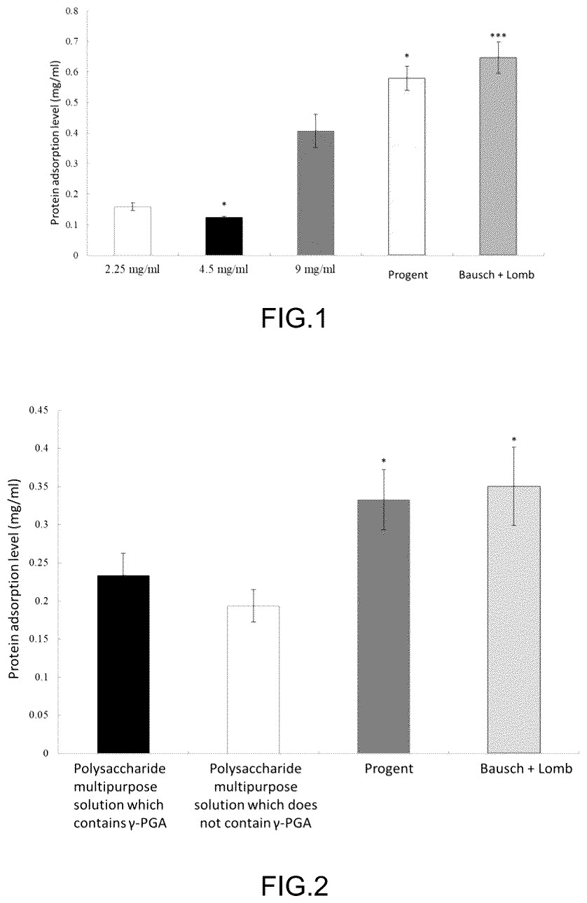

The multipurpose solutions contain 2.25, 4.5, and 9 mg/ml of alginic acid and carrageenan, respectively. The contact lenses are immersed in bionic tears for three days and then rinsed. As shown in FIG. 1, the amount of proteins adsorbed on the contact lenses rinsed with the multipurpose solutions which contain alginic acid and carrageenan is much less than the amount of proteins adsorbed on the contact lenses rinsed with commercially-available Progent® multipurpose solution and Bausch+Lomb® multipurpose solution.

The amount of proteins adsorbed on contact lenses rinsed with 4.5 mg/ml of alginic acid and carrageenan multipurpose solution which contains 1.5% γ-PGA is not only less than the amount of proteins adsorbed on contact lenses rinsed with 4.5 mg/ml of alginic acid and carrageenan multipurpose solution which does not contain γ-PGA but also much less than the amount of proteins adsorbed on contact lenses rinsed with the commercially-available multipurpose solutions (FIG. 2).

The present disclosure is illustrated by embodiments. Persons skilled in the art easily understand that the embodiments are illustrative rather than restrictive. Persons skilled in the art may make changes and replacements to the embodiments without departing from technical features disclosed herein. As indicated by the embodiments of the present disclosure, changes can be made to the present disclosure without affecting the implementation thereof. The teachings embodied in the embodiments may be combined as long as the combination is not contradictory. The scope of the present disclosure shall be defined by the appended claims and shall cover the aforesaid method and structure as well as equivalents thereof.

### REFERENCE

[1] Chang D C, Grant G B. Multistate outbreak of fusarium keratitis associated with use of a contact lens solution. American Journal of Ophthalmology. 2006; 142(5): 896-897.
[2] Nichols J J, Chalmers R L. The case for using hydrogen peroxide contact lens care solutions: A review. Eye Contact Lens. 2019; 45(2):69-82.
[3] Koffler B H, Karpecki P M. Positive aspects of the use of multipurpose disinfection solutions. Arch Ophthalmol. 2009; 127:1540-1543.
[4] Kilvington S, Huang L, Kao E, Powell C H. Development of a new contact lens multipurpose solution: comparative analysis of microbiological, biological and clinical performance. J Optom. 2010; 3(3):134-142.
[5] Barniak V L, Burke S E, Venkatesh S. Comparative evaluation of multi-purpose solutions in the stabilization of tear lysozyme. Cont Lens Anterior Eye. 2010; 33S:S7-S11.
[6] Luensmann D, Jones L. Deposition on contact lenses: the past, the present, and the future. Cont Lens Anterior Eye. 2012 April; 35(2):53-64.
[7] Green-Church K B, Nichols K K., Kleinholz N M., Zhang L., Nichols J J. Investigation of the human tear film proteome using multiple proteomic approaches. Mol Vis. 2008; 14:456-470.
[8] Omila N B, Subbaraman L N, Coles-Brennan C, Fadli Z, Jones L W. Biological and clinical implications of lysozyme deposition on soft contact lenses. Optom Vis Sci. 2015 July; 92(7):750-7.
[9] Bajpai A K, Mishra D D. Adsorption of a blood protein on to hydrophilic sponges based on poly(2-hydroxyethyl methacrylate). J Mater Sci Mater Med. 2004; 15:583-592.
[10] Stapleton F, Willcox M D, Morris C A, Sweeney D F. Tear changes in contact lens wearers following overnight eye closure. Curr Eye Res. 1998; 17:183-188.
[11] Skotnitsky C C, Naduvilath T J, Sweeney D F, Sankaridurg P R. Two presentations of contact lens-induced papillary conjunctivitis (CLCP) in hydrogel lens wear: local and general. Optom Vis Sci. 2006; 83(1):27-36.
[12] Bontempo A R, Rapp J. Protein-lipid interaction on the surface of a rigid gas-permeable contact lens in vitro. Curr Eye Res. 1997; 16(12):1258-1262.
[13] Omali N B, Subbaraman L N. Surface versus bulk activity of lysozyme deposited on hydrogel contact lens materials in vitro. Cont Lens Anterior Eye. 2018; 41(4): 329-334.

1. A polysaccharide composition for reducing protein adsorption, essentially comprising alginic acid, carrageenan and buffer solution.

2. The composition of claim 1, further comprising γ-polyglutamic acid (γ-PGA).

3. The composition of claim 1, wherein a ratio of the alginic acid to the carrageenan is 1:1.

4. The composition of claim 1, wherein both the alginic acid and the carrageenan have a concentration of 1˜10 mg/ml.

5. The composition of claim 1, wherein both the alginic acid and the carrageenan have a concentration of 2.25˜9 mg/ml.

6. The composition of claim 1, wherein the buffer solution has a pH of 6.5˜7.5.

7. The composition of claim 1, which is a hard contact lens cleaning solution or multipurpose solution.

8. A method of using the composition of claim 1 to manufacture a reagent for reducing protein adsorption.

9. The method of claim 8, wherein the reagent is a hard contact lens cleaning solution or multipurpose solution.
